(19) United States
(12) Patent Application Publication
(10) Pub. No.: US 2020/0117294 A1
(43) Pub. Date: Apr. 16, 2020

(54) INPUT UNIT AND ELECTRONIC DEVICE

(71) Applicant: CASIO COMPUTER CO., LTD., Tokyo (JP)

(72) Inventor: Takashi SUENAGA, Tokyo (JP)

(73) Assignee: CASIO COMPUTER CO., LTD., Tokyo (JP)

(21) Appl. No.: 16/653,741

(22) Filed: Oct. 15, 2019

(30) Foreign Application Priority Data
Oct. 16, 2018 (JP) 2018-195237

(51) Int. Cl. G06F 3/044; G06F 3/041

(52) U.S. Cl. CPC G06F 3/044; G06F 3/0418

(57) ABSTRACT

An input unit includes: a touch panel of a capacitive type configured to detect a touch operation by a user; and an accessary member attached to the touch panel. The accessary member has a specific part above a detection face of the touch panel, the specific part includes a resistive element, and a touch operation to the accessary member by the user enables a touch operation to the touch panel.

### BACKGROUND

An embodiment relates to the technique field of input units and electronic devices.

Recently electronic devices, such as a smart phone and a tablet, include a touch panel as an input unit, and the touch panel is placed on the front face (the face for viewing or toward the user's eyesight) of the display unit, such as a liquid crystal display. JP 2016-176732A, for example, describes an electronic device including a conductive element (non-resistive element) in a case surrounding the display unit so as to enable the user's touch operation at the case.

Although the electronic device described in JP 2016-176732A enables the detection of user's touch operation at the case, this configuration includes the non-resistive element and so locally has a part of the case without the non-resistive element that is lower in detection accuracy of the touch position. That is, the detection accuracy of the touch position depends on the position of the non-resistive element in the case. This means that the detection accuracy of the touch position easily changes in the case.

### SUMMARY

To solve the problem, an input unit in one embodiment includes: a touch panel of a capacitive type configured to detect a touch operation by a user; and an accessary member attached to the touch panel. The accessary member has a specific part above a detection face of the touch panel, a part or the entire of the specific part is formed with the resistive element, and a touch operation to the accessary member by the user enables a touch operation to the touch panel.

### BRIEF DESCRIPTION OF THE DRAWINGS

FIG. 1A and FIG. 1B schematically show the configuration of an electronic device as one example, which includes an input unit according to one embodiment.

FIG. 2A and FIG. 2B schematically show a cross-sectional configuration of a major part of the electronic device according to one embodiment.

FIG. 3 describes a change in capacitance of one example.

FIG. 4 schematically shows an electronic device according to a first modified example.

FIG. 5 schematically shows an electronic device according to a second modified example.

FIG. 6 schematically shows a cross-sectional view of an electronic device according to a third modified example.

### DETAILED DESCRIPTION OF THE PREFERRED EMBODIMENTS

Referring to the attached drawings, the following describes embodiments in details.

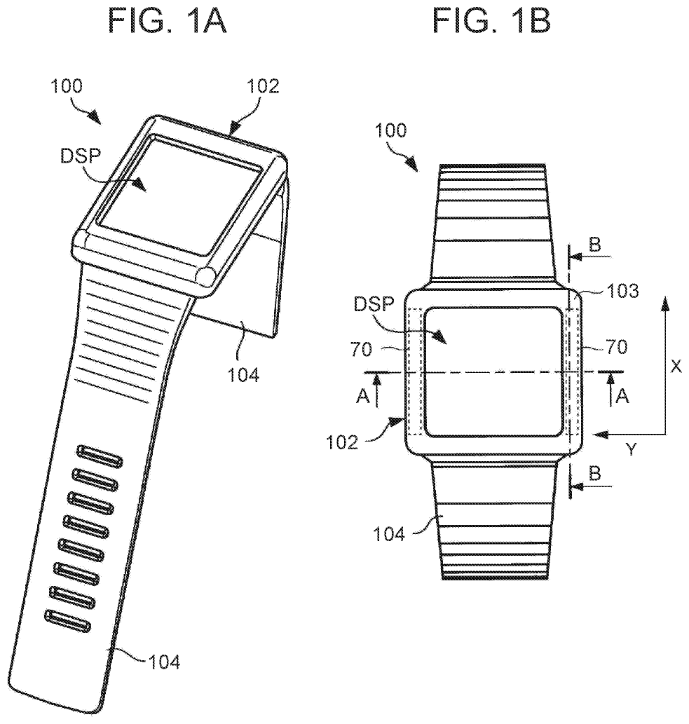

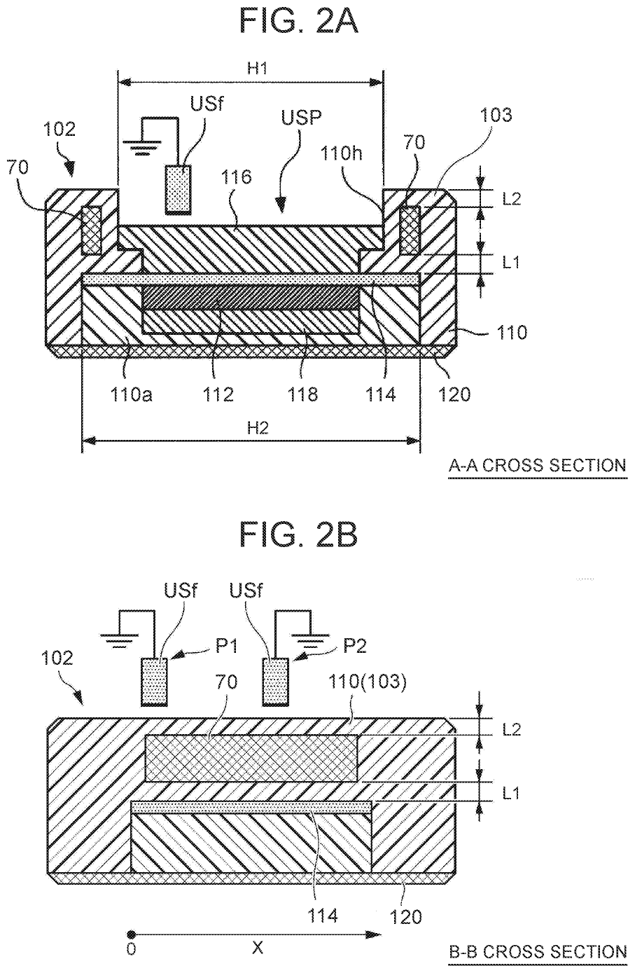

FIG. 1A and FIG. 1B schematically show the configuration of an electronic device as one example. FIG. 1A is a perspective view of the appearance of an electronic device according to this example. FIG. 1B is a front view of the body of the electronic device viewed from the user. FIG. 2 schematically shows a cross-sectional configuration of a major part of the electronic device according to this example. Specifically FIG. 2A shows a cross-sectional configuration taken along the line A-A of the electronic device in FIG. 1B, and FIG. 2B shows a cross-sectional configuration taken along the line B-B. FIG. 1B shows X-direction corresponding to the vertical direction of the screen of the display unit DSP and Y-direction corresponding to the horizontal direction of the screen. The Y-direction may be referred to as the left-right direction.

The electronic device 100 has a shape like a wristwatch. As shown in FIG. 1A and FIG. 1B, for example, the electronic device 100 includes a body 102 having a display unit DSP to display various types of information in accordance with the operation and the function, and a strip-shaped belt (accessary member) 104 for attachment of the body 102 on the human body, such as on a wrist.

As shown in FIG. 1A and FIG. 1B, for example, the body 102 has a substantially rectangular flat face. The body 102 includes a display unit DSP having a touch panel on one face toward the user's eyesight (the upper face in FIG. 1A, the front face in FIG. 1B, and the upper face in FIG. 2A and FIG. 2B), and includes a bottom lid (closing lid) 120 on the other face (the lower face in FIG. 2A and FIG. 2B) of the body 102.

Specifically as shown in FIG. 2A and FIG. 2B, for example, the body 102 has a resin case 110 like a frame that is a dielectric having an insulating property. The body 102 includes a protective plate 116, a display panel 112 of a liquid-crystal type, for example, a touch panel 114 of a capacitive type, a circuit unit 118 including a circuit board, a battery and the like, and a fixing member 110a that are assembled (accommodated) in an opening 110h that penetrates through the case 110 at the center. The display panel 112, the touch panel 114 and the protective plate 116 make up the display unit DSP. The touch panel 114 has a face for viewing that functions as a detection face to detect the touch position (touch coordinates). The touch panel 114 and the protective plate 116 are transparent so as to allow the display on the display panel 112 to be viewed from the above. The protective plate 116 may be made of glass, for example. In this example, the touch panel 114 and the case 110 (one example of the accessary member) make up one example of an “input unit”.

The protective plate 116 is not limited to glass, which may be made of a resin material having transparency, such as acrylics or polycarbonates. The case 110 may be made of a material other than dielectrics at a part other than the above of the touch panel 114 to dispose a resistive element 70 described later.

The protective plate 116 is attached at a position closest to the user's eyesight in the opening 110h of the case 110. The touch panel 114 comes in close contact with the protective plate 116 on the surface that is a detection face, and comes in close contact with the display panel 112 on the other face. As shown in FIG. 2A, for example, the touch panel 114 has a width (length in the left-right direction of the drawing) H2 that is larger than a width H1 of the opening 110h of the case 110 at a part closer to the surface, so that the ends of the touch panel 114 extend to a part of the case 110 surrounding (surrounding in the left-right direction of the drawing) the display unit DSP. Note here that a part of the case 110 surrounding the display unit DSP of the body 102 corresponds to a bezel of the wristwatch, and hereinafter this part is called a bezel 103.

The circuit unit 118 including a circuit board, a battery and the like is disposed on the other face of the display panel 112 (closer to the bottom lid 120). Although the details are not shown, the circuit unit 118 includes a circuit-board unit including an arithmetic processing circuit, such as a CPU or MPU, and a memory circuit, and a power-supply unit to supply electricity to drive various parts of the body 102. The fixing member 110a is fitted into the opening 110h on the other face of the case 110 to fix the touch panel 114, the display panel 112, and the circuit unit 118 assembled in the opening 110h. The bottom lid 120 closes the opening 110h on the other face of the case 110, in which the touch panel 114, the display panel 112, the circuit unit 118, and the fixing member 110a are assembled.

As shown in FIG. 2A, the body 102 is configured so that the case 110 surrounding the display unit DSP protrudes from the surface of the protective plate 116 of the display unit DSP toward the surface (toward the user's eyesight or upward of FIG. 2A). This is to improve the strength against breakage or impact during the usage of the electronic device 100 or to improve the design.

As shown in FIG. 1B, FIG. 2A, and FIG. 2B, the part of the case 110 surrounding the display unit DSP and protruding from the display unit DSP, i.e., the bezel 103 (one example of a specific part) in this example internally includes a resistive element 70 so as to overlap with the touch panel 114, which has the ends that extend beyond the width H1 of the opening 110h, in the plan view of the body 102 from the surface. In one example, the resistive element 70 is made of a material having a relatively low resistance value (e.g., about 1×10⁻⁵Ω to 2×10⁻⁵Ω), such as carbon. The resistive element 70 has a resistance value that is lower than that of a part of the bezel 103 other than the resistive element 70.

The resistive element 70 has an outer shape along the outer shape of the bezel 103 (having a rectangular frame shape in the example of FIG. 1B). FIG. 1B shows a plurality of resistive elements 70 that are disposed on the left and the right of the bezel 103 to extend along the left side and the right side of the bezel 103 (in the vertical direction of the display unit DSP).

As shown FIG. 2, the resistive elements 70 are not exposed above the upper face of the bezel 103 and are not extend to the touch panel 114 as well. In other words, the resistive elements 70 are embedded in the bezel 103, so that dimensions L1 and L2 in FIG. 2 are larger than zero. This prevents the degradation of appearance due to exposure of the resistive element 70, and so improves the design. The dimension L1 is a distance between the resistive element 70 and the touch panel 114, and the dimension L2 is a distance between the resistive element 70 and the surface of the case 110. In a modified example, any one of the dimensions L1 and L2 or both of them may be zero. FIG. 2 shows the example where the dimensions L1 and L2 are substantially the same, which may be significantly different.

In this example, a user may touch the protective plate 116 disposed closer to the user's eyesight than the touch panel 114 of the display unit DSP with a finger USf, for example, for input operation (see FIG. 2A). A user also may touch the bezel 103 with a finger USf, for example, for input operation (see FIG. 2B).

When a user touches the protective plate 116 with a finger USf, for example, the capacitance of the touch panel 114 changes, and the circuit unit 118 of the electronic device 100 accordingly detects the touch position. Detecting a touch position in this way, the circuit unit 118 of the electronic device 100 then implements various functions based on the touch position and the current screen information, for example.

Similarly when a user touches the bezel 103 with a finger USf, for example, the capacitance of the touch panel 114 changes, and the circuit unit 118 of the electronic device 100 accordingly detects the touch position. Detecting a touch position in this way, the circuit unit 118 of the electronic device 100 then implements various functions based on the touch position and the current screen information, for example.

The circuit unit 118 enables distinguishing between the operation on the protective plate 116 and the operation on the bezel 103 based on the touch position. The circuit unit 118 may implement various types of functions based whether the operation is performed on the protective plate 116 or on the bezel 103. In one example, the operation on the protective plate 116 may correspond to the operation of a touch switch that is formed on the display screen of the display unit DSP, and the operation on the bezel 103 may correspond to the scroll operation of the display screen of the display unit DSP. In another example, the operation on the bezel 103 may implement certain functions, such as “back” and “forward”. In this case, a user may customize the functions allocated to the operations on the bezel 103.

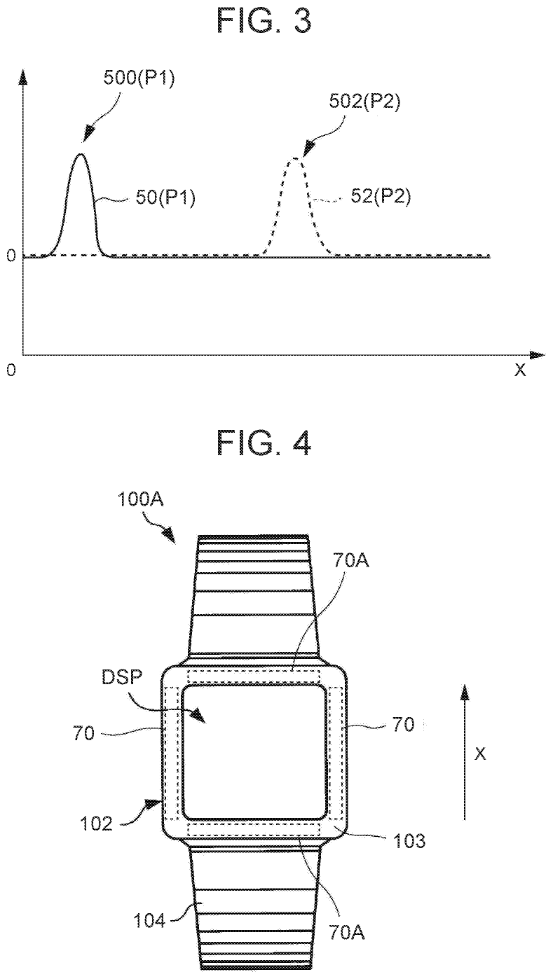

Referring next to FIG. 2 as well as FIG. 3 and the following drawings, the advantageous effects of this example are described below.

FIG. 3 describes a change in capacitance of this example.

As described below, this example includes the resistive elements 70 as stated above and so reduces the positional dependence of the detection accuracy for touch operation in the bezel 103.

More specifically FIG. 3 shows the characteristics of this example, and the vertical axis of this drawing represents the capacitance and the horizontal axis represents the position (position in the X-direction). The waveform 500 (P1) indicates a change in capacitance in the X-direction of the touch panel 114 when the finger USf is at position P1 of FIG. 2B, and the waveform 502 (P2) indicates a change in capacitance in the X-direction of the touch panel 114 when the finger USf is at position P2 of FIG. 2B.

When the finger USf is at the position P1 of FIG. 2B, the finger USf is opposed to the resistive element 70 in the up-down direction (the direction perpendicular to the display unit DSP), so that as shown with the waveform 50 (P1) of FIG. 3, the waveform has a relatively large peak at the position opposed to the finger USf, and favorable detection accuracy is accordingly expected for the touch position (position in the X-direction). Also when the finger USf is at the position P2 of FIG. 2B, the waveform has a relatively large peak at the position opposed to the finger USf as shown with the waveform 52 (P2) of FIG. 3, and favorable detection accuracy is accordingly expected for the touch position (position in the X-direction). Unlike a conductive element, the resistive element 70 has significant resistance. This makes the position of a peak in capacitance clearly different between when the finger USf is at the position P1 of FIG. 2B and when the finger USf is at the position P2 of FIG. 2B.

In this way, this example leads to easy generation of a clear peak in capacitance for any position of the finger USf in the bezel 103 as long as the finger is opposed to the resistive element 70 in the up-down direction. As a result this example reduces the positional dependence of the detection accuracy for touch operation in the bezel 103, and so improves the detection accuracy of the touch position.

This example therefore enables the detection of touch operation for a plurality of positions on the touch panel 114 individually based on a user's touch operation at a plurality of positions each overlapping with one resistive element 70 in the bezel 103 that correspond to the plurality of positions on the touch panel 114. That is, this example differentially detects user's touch operation at a plurality of positions each overlapping with one resistive element 70, and so allocates a different function corresponding to a different position to the touch operation. As a result this example efficiently increases the number of touch switches that are mountable per unit area.

The above example includes the resistive elements 70 disposed on the left and the right of the bezel 103, and the resistive element 70 may be disposed on one of the left and the right of the bezel 103. Each resistive element 70 in the above example is disposed along the overall height from the upper end to the lower end of the screen of the display unit DSP. The resistive element 70 may be disposed at a part of the height from the upper end to the lower end of the screen of the display unit DSP, or may extend beyond the upper end or the lower end of the screen of the display unit DSP.

Referring next to FIG. 4 and the following drawings, the following describes some modified examples.

FIG. 4 schematically shows an electronic device 100A according to a first modified example. The electronic device 100A according to the first modified example is different from the electronic device 100 in the above example in that the electronic device 100A additionally includes resistive elements 70A. The following may refer to a part on the positive side in the X-direction of the bezel 103 as an upper part and a part on the negative side in the X-direction as a lower part.

As shown FIG. 4, the electronic device 100A additionally includes the resistive elements 70A at the upper and lower parts of the bezel 103. Specifically the resistive element 70A at the upper part of the bezel 103 extends in the left-right direction, and the resistive element 70A at the lower part of the bezel 103 extends in the left-right direction. The structure of these resistive elements 70A in the bezel 103 may be similar to that of the resistive element 70.

In this way the bezel 103 in the first modified example includes the resistive elements 70 that are continuous in the vertical direction of the screen on the left and the right of the bezel 103 as well as the resistive elements 70A that are continuous in the left-right direction of the screen at the upper part and the lower part of the bezel.

The circuit unit 118 in this example may implement various types of functions based on the touch position and based on the part of the bezel 103 where the touch operation is performed. In one example, the operation at various parts of the bezel 103 may implement certain functions, such as “back” and “forward”. In this case, a user may customize the functions allocated to the operations on the bezel 103.

This modified example has similar advantageous effects to those of the above-stated example.

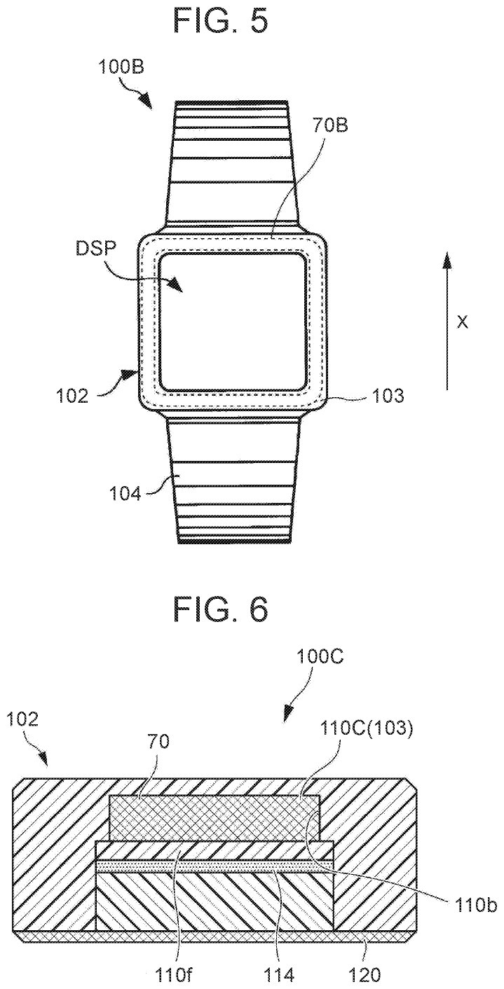

FIG. 5 schematically shows an electronic device 100B according to a second modified example. The electronic device 100B according to the second modified example is different from the electronic device 100 in the above example in that the electronic device 100B includes a resistive element 70B instead of the resistive elements 70.

As shown FIG. 5, the resistive element 70B is continuous along the entire circumference of the bezel 103. The structure of this resistive element 70B in the bezel 103 may be similar to that of the resistive element 70.

The circuit unit 118 in this example may implement various types of functions based on the touch position and based on the part of the bezel 103 where the touch operation is performed. In one example, the operation at various parts of the bezel 103 may implement certain functions, such as “back” and “forward”. In this case, a user may customize the functions allocated to the operations on the bezel 103.

This modified example has similar advantageous effects to those of the above-stated example.

In this way, the arrangement pattern or the number of resistive elements in the bezel 103 may be changed as needed.

FIG. 6 schematically shows a cross-sectional view of an electronic device 100C according to a third modified example.

The electronic device 100C according to the third modified example is different from the electronic device 100 in the above example in that the electronic device 100C includes a case 110C instead of the case 110. The case 110C is different from the case 110 in the above example in that a part 110f between the resistive element 70 and the touch panel 114 is different from the other part.

The case 110C in this modified example has a recess 110b to accommodate the resistive element 70. More specifically the cross-sectional structure of FIG. 6 may be manufactured by fitting the resistive element 70 into the recess 110b and placing the part 110f as a lid. This reduces the number of the resistive elements 70 and assembles the resistive element 70 so as to be fitted into the corresponding recess 110b, and accordingly improves the manufacturability.

That is the detailed descriptions on the examples, and the present invention is not limited to these specific examples. The above-stated examples may be variously modified or changed within the range specified in the claims. All of or a plurality of the elements in the above-stated examples may be combined.

In one example, while the above-stated examples include a rectangular display unit DSP of the electronic device 100, the display unit may have any shapes, such as a round shape, a substantially round shape having a linear portion at a part, and polygons. In the case of a round display unit, the resistive element 70 as in the second modified example shown in FIG. 5, for example, may have a ring-shape.

The above-stated examples include the touch panel 114 that is a single panel having a part in contact with the protective plate 116 and a part extending in the case 110. In another example, the touch panel may be divided into a part in contact with the protective plate 116 and a part extending in the case 110.

The above-stated examples describe the electronic device having a wristwatch shape in details, and the present invention is not limited to this. In another example, the present invention is favorably applicable to compact electronic devices, such as a smart phone, a tablet, a digital camera, and various types of wearable devices, that include a touch panel of the display unit disposed closer to the user's eyesight and a case surrounding the display unit that protrudes from or is thicker than the display unit, or that are configured so that the case has a dielectric constant different from that of the protective plate.

What is claimed is:

1. An input unit, comprising:
a touch panel of a capacitive type configured to detect a touch operation by a user; and
an accessary member attached to the touch panel;
wherein
the accessary member has a specific part above a detection face of the touch panel,
the specific part includes at least one resistive element, and
a touch operation to the accessary member by the user enables a touch operation to the touch panel.

2. The input unit according to claim 1, wherein
the specific part includes a plurality of resistive elements, and the touch panel differentially detects a touch operation to a plurality of positions on the touch panel based on a touch operation by the user at a plurality of positions each overlapping with one of the resistive elements in the accessary member corresponding to the plurality of positions on the touch panel.

3. The input unit according to claim 1, wherein the specific part is disposed above a part of the detection face of the touch panel.

4. The input unit according to claim 2, wherein the specific part is disposed above a part of the detection face of the touch panel.

5. The input unit according to claim 1, wherein the resistive element is embedded in the specific part.

6. The input unit according to claim 2, wherein the resistive element is embedded in the specific part.

7. The input unit according to claim 3, wherein the resistive element is embedded in the specific part.

8. The input unit according to claim 4, wherein the resistive element is embedded in the specific part.

9. The input unit according to claim 1, wherein the resistive element is continuous along a shape of the accessary member.

10. The input unit according to claim 1, wherein
the input device is for a wristwatch-type electronic device,
the specific part is a bezel, and
the accessary member is a case.

11. The input unit according to claim 1, wherein
the resistive element has a resistance value that is lower than a resistance value of a part of the specific part other than the resistive element.

12. An electronic device comprising: the input unit according to claim 1; and
a display panel accommodated in the accessary member,
wherein
the touch panel is disposed on a face of the display panel closer to eyesight of the user so that the touch panel is surrounded with the accessary member.
